(19) United States
(12) Patent Application Publication
(10) Pub. No.: US 2015/0248711 A1
(43) Pub. Date: Sep. 3, 2015

(54) AUTONOMOUS SELF-POWERED AIRBORNE COMMUNICATION AND MEDIA STATION, AND METHOD OF USING IT FOR DISPLAYING, BROADCASTING AND RELAYING DATA

(71) Applicant: SOLAR SHIP INC., Toronto (CA)

(72) Inventors: Sebastien Fournier, Toronto (CA); Jay Godsall, Toronto (CA)

(21) Appl. No.: 14/430,576

(22) PCT Filed: Sep. 27, 2013
(86) PCT No.: PCT/CA2013/000817

§ 371 Date: Mar. 24, 2015

Related U.S. Application Data
(60) Provisional application No. 61/706,321, filed on Sep. 27, 2012.

(51) Int. Cl. G06Q 30/02; B64D 47/00; B64D 41/00; B64B 1/06; B64B 1/58

(52) U.S. Cl. CPC G06Q 30/0275; B64B 1/06; B64B 1/58; B64D 41/00; B64D 47/00

(57) ABSTRACT

An airship or airborne station comprises a gas-containing envelope for containing a lifting gas, solar panels on the envelope for providing electric power to an energy storage system, and an external display screen powered by the energy storage system. This airship or airborne station enables novel methods of using the airship or airborne station to display digital content, to sell or auction ad space on the display screen to the highest bidder, to display information for events, crowds, rescue operations, or to interact digitally with a group of wireless communications devices. Furthermore, the airship or airborne station acts as a communication and media hub for uploading user-generated content, relaying communications from wireless devices, broadcasting content or interactive media.

### TECHNICAL FIELD

The present technology relates generally to aerospace and aircraft and, in particular, to airships, hybrid airships or other airborne stations.

### BACKGROUND

An airship uses a lifting gas such helium or hydrogen to provide lift. A hybrid airship gains lift from both the lifting gas and an aerofoil-shaped wing that also provides aerodynamic lift. Solar airships (or hybrid airships) use the large surface area on the envelope for collection of solar radiation for generating electric power to power electrically driven propellers.

It is well known in the art to use the external surface of an airship to display advertising, e.g. the Goodyear blimp at major sports events. More recently, the Goodyear blimp has been refitted with a light-emitting diode (LED) screen that functions as an electronic signboard.

A similar technology for displaying video images on a video screen disposed on the external surface of an airship is disclosed in U.S. Pat. No. 7,173,649 (Shannon), which is incorporated herein by reference in its entirety for those jurisdictions where incorporations by reference are permitted under national law. A low-power, lightweight LED display screen mountable on airship is disclosed in U.S. Patent Application Publication 2010/0309185 (Koester et al.), which is incorporated herein by reference in its entirety for those jurisdictions where incorporations by reference are permitted under national law. An internal video projection system for an airship is disclosed in U.S. Patent Application Publication 2002/0171927 (Barnes, III), which is incorporated herein by reference in its entirety for those jurisdictions where incorporations by reference are permitted under national law.

Improvements on these technologies remain highly desirable. It is also desirable to develop new business methods for exploiting these technologies.

### SUMMARY

In general, the present invention provides an air-based or airborne station (e.g. an aircraft, airship, air vehicle, flying boat or other flying machine or apparatus) having an external display screen for displaying digital content. The airborne station may be any air vehicle, whether manned or unmanned, including aircraft, airships, hybrid airships, tethered or untethered aerostats, dirigibles, or balloons, or the like. The digital content may be stored in a memory onboard the airborne station and/or received wirelessly by the airborne station. In addition to displaying content, either as static images or dynamic media (or video), the airborne station can broadcast or transmit data to nearby wireless communications devices (mobile devices, smart phones, tablets, etc) or wireless-enabled computing devices. The airborne station can be used to interact with users of these devices, e.g. by soliciting responses, feedback, votes, etc. in relation to content that is displayed or broadcast. In addition, the airborne station is capable of acting as a communications hub or relay by relaying communications (voice calls, e-mails, SMS messages, tweets, etc.) via a cellular or satellite link. In one main implementation, the airborne (or air-based) station is an airship.

Thus, an aspect of the present invention is an airship comprising a gas-containing envelope for containing a lifting gas, solar panels on the envelope for providing electric power to an energy storage system and an external display screen powered by the energy storage system. In one implementation, the airship includes a radiofrequency transceiver for receiving data, e.g. a digital photo or video, for the display screen, wherein the transceiver is powered by the energy storage system, a memory powered by the energy storage system for storing data received by the transceiver and a processor, also powered by the energy storage system, for processing the data stored by the memory and for causing the data to be displayed as digital content on the external display screen. In one implementation, ad space on the display may be auctioned, e.g. the memory and processor may be configured to determine real-time pricing for ad space on the display screen, transmit the pricing to a plurality of wireless communications devices, receive bids from one or more of the wireless communications devices and receive an ad from a bid-winning wireless communications device for displaying on the display screen of the airship. In another implementation, the airship may include a satellite transceiver for relaying communications from wireless communications devices. In another implementation, the airship broadcasts data to a plurality of wireless communications devices and receives data, e.g. votes, from the wireless communications devices. As will be appreciated, the airship functions as a communication and media hub.

Another aspect of the present invention is a method of using an airship having an external display screen on a gas-containing envelope of the airship, the method comprising generating electric power using solar panels on the envelope, storing the electric power in an energy storage system, receiving data representing digital content, and displaying the digital content on the external display screen. In one implementation, the data may be user-generated content uploaded from a wireless communications device, e.g. a digital photo or video. In another implementation, the ad space on the display screen is auctioned or sold to the highest bidder. In another implementation, the airship broadcasts data to local wireless communications devices and receives data from these devices, e.g. votes. In another implementation, the airship relays communications from wireless communications device, e.g. via a satellite link. As will be appreciated, many novel methods are enabled by this airship.

Yet another aspect of the present invention is an airborne station comprising a gas-containing envelope for containing a lifting gas, solar panels on one or both of the envelope for providing energy and an external display screen powered by the energy from the solar panels. The airborne station may, in one implementation, be an airship, particularly a hybrid airship having a gas-containing envelope having a fuselage and wings.

Yet another aspect of the present invention is an autonomous self-powered airborne communication station comprising a gas-containing envelope for containing a lifting gas, solar panels on the envelope for generating energy, and a communication relay subsystem having a radiofrequency transceiver powered by the energy from the solar panels for relaying a communication signal between a wireless communications device and a base station transceiver.

Yet another aspect of the present invention is an autonomous self-powered airborne communication and media station comprising a gas-containing envelope for containing a lifting gas, solar panels on the envelope for generating energy, a communication relay subsystem powered by the energy from the solar panels, and an external display that is also powered by the energy from the solar panels, the display being disposed on the envelope for displaying digital media content.

Other aspects of the present invention are described below in relation to the accompanying drawings.

### BRIEF DESCRIPTION OF THE DRAWINGS

Further features and advantages of the present technology will become apparent from the following detailed description, taken in combination with the appended drawings, in which:

FIG. 1 is a schematic depiction of an airship with a display screen that also functions as a communication and media hub in accordance with embodiments of the present invention;

FIG. 2 is a view of an airship in accordance with an embodiment of the present invention;

FIG. 3 is a view of an airship displaying advertising on display screens;

FIG. 4 is another view of an airship displaying advertising on display screens;

FIG. 5A-5F are views of an airship with display screens; and

FIG. 6 is an isometric view of another embodiment of an airship which may be used as a communication and media hub.

It will be noted that throughout the appended drawings, like features are identified by like reference numerals.

### DETAILED DESCRIPTION

In general, the present invention provides a novel air-based or airborne station (e.g. an aircraft, airship, air vehicle, flying boat or other flying machine or apparatus) having an external display screen for displaying digital content. In one main implementation, this air-based or airborne station is a self-reliant, self-contained (i.e. autonomous, self-powered) solar-powered airship with an external display screen for displaying digital content to users (content consumers) within viewing range of the airship. The airship is said to be autonomous and self-powered because all power needed to operate the aircraft (i.e. drive the propulsion system, operate onboard electronics, etc.) and all power needed to power the communication and media hub (i.e. communication relay subsystem and media display subsystem) comes from the solar-generated power generated by the solar cells on the outer skin on the aircraft. This enables the aircraft to operate potentially indefinitely in areas where conventionally-fuelled aircraft would be unable to remain.

Content displayed on the airship may be transmitted remotely to the airship from a satellite or ground-based broadcast antenna or it may even be uploaded by a person using a mobile device as user-generated content. In addition, as will be elaborated below, the airship may broadcast and receive data to and from nearby wireless devices or act as a relay to relay communications from wireless devices. This airship enables various new business methods which will also be described below.

### Airship

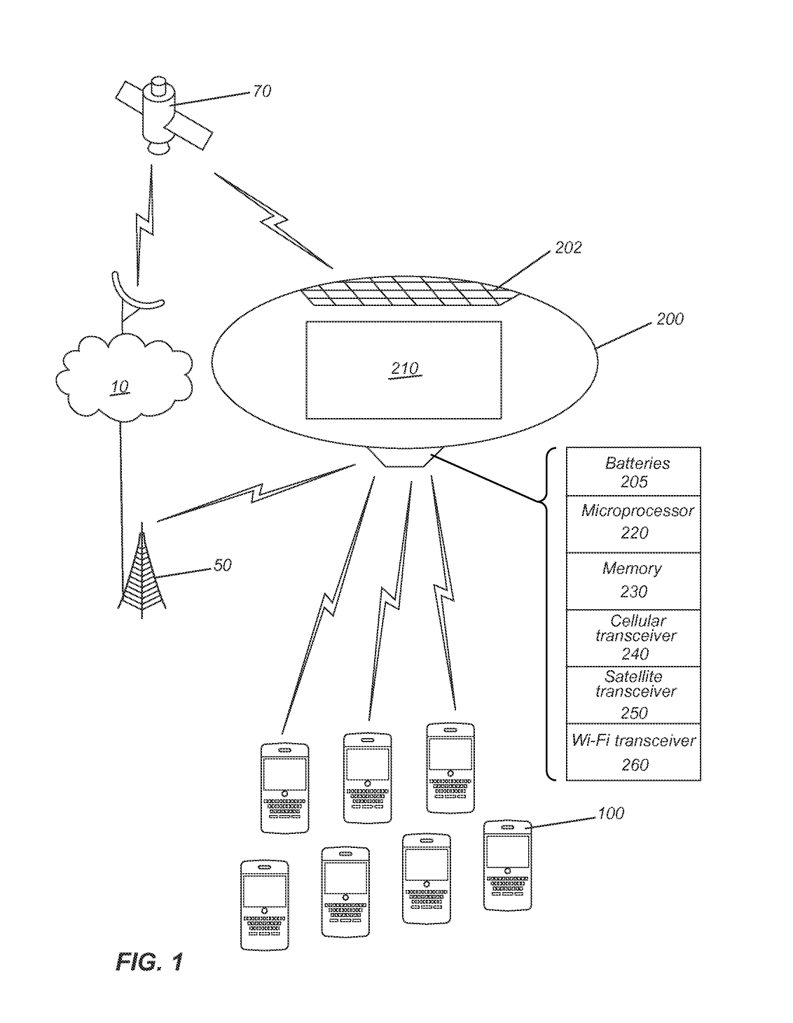

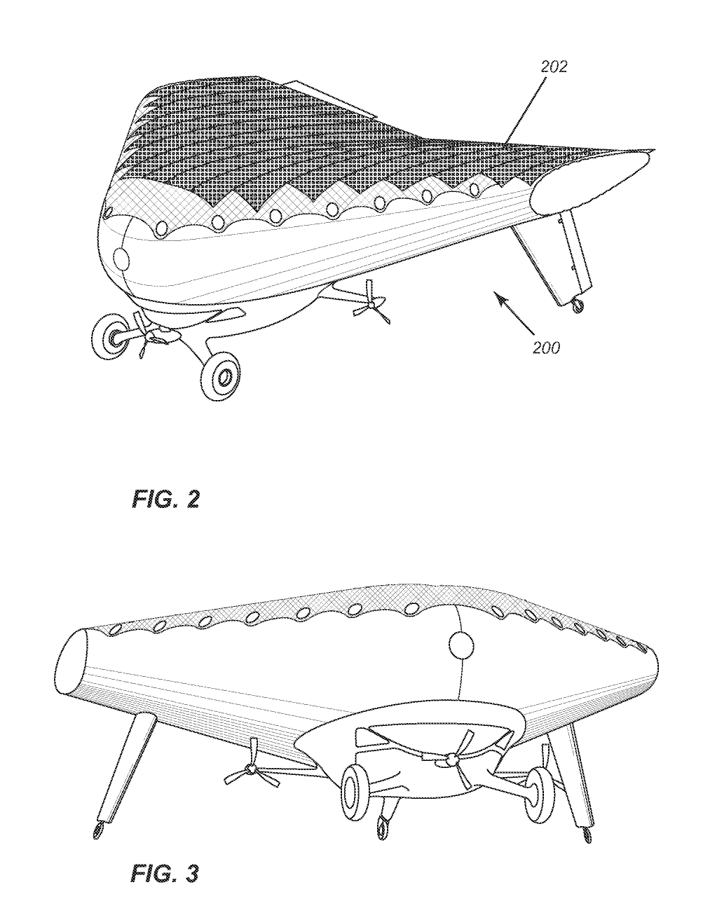

In the embodiment depicted by way of example in FIG. 1 and FIG. 2, an airship 200 comprises a lifting gas-containing envelope and solar panels 202 on the envelope for generating electric power and for providing the generated electric power to an energy storage system 205 (which may comprise one or more batteries and/or ultra-capacitors).

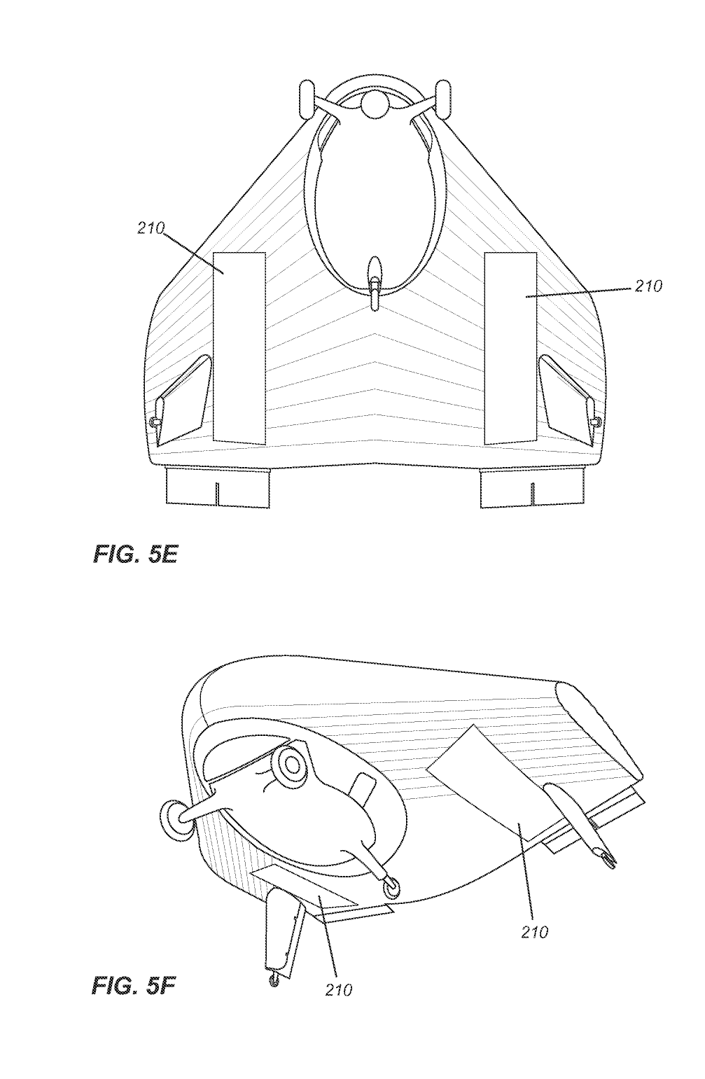

The airship has an external display screen 210 powered by the energy storage system. The display screen may use LED, OLED or quantum dot technology or any other suitable display technology. The display screen may be arranged in rows and columns of pixels. The display screen may have any regular or irregular shape and may disposed around the contours of the outer skin or envelope of the airship. The display screen may be externally mounted to the envelope or embedded (integrated) directly into the fabric of the envelope. The display screen may be controlled by a dedicated microprocessor 220 (or simply a “processor”), or by a media hub having a general-purpose processor executing media display software. The display screen may be disposed on the side or underside of the fuselage, on the underside of the wings or anywhere else on the outer surface of the envelope of the airship that does not interfere with the functioning of the solar panels. In other words, in one main embodiment, the solar panels occupy a surface area of the envelope that is distinct from the surface area occupied by the display screen. In a variant, there may be more than one display screen. For example, as shown in FIGS. 5E-5F, there may be two display screens on the airship. External speakers may also be provided to broadcast audio to accompany the images and/or video being displayed on the display screen. Alternatively, an audio signal may be broadcast to the nearby wireless communications device to permit the devices to locally play the audio content via device speakers or output jack-connected headphones. The media display software may implement image-control algorithms to regulate image output characteristics such as brightness, luminosity, contrast, coloration, resolution, etc. based on ambient light conditions and/or the availability of onboard electric power (e.g. current battery level). The media display software may also provide a signal to the aircraft to reposition itself for optimal viewing (based on the position of the sun, cloud cover, etc.)

In one embodiment, the airship includes a radiofrequency transceiver for receiving data for the display screen. The transceiver may be a cellular transceiver 240, satellite transceiver 250 and/or a short-range wireless transceiver such as a Wi-Fi transceiver 260. Instead of Wi-Fi™ (IEEE 802.11), the transceiver may be any other suitable short-range wireless transceiver using a known short-range wireless protocol such as, for example, WiMAX, ZigBee® (IEEE 802.15), Bluetooth®, Z-Wave®. The airship may also include long-range Wi-Fi (also called WiLD) to cover longer distances of, for example, 80-100 km. The airship may also be equipped with a plurality of different transceivers to handle different wireless communication protocols. Each transceiver is powered by the energy storage system. The airship also includes a memory 230 powered by the energy storage system for storing data received by the transceiver and a processor, also powered by the energy storage system, for processing the data stored by the memory and for causing the data to be displayed as digital content on the external display screen. The processor 220, memory 230 and any software stored and executed by the memory and processor constitute the onboard media hub in this embodiment.

The data received by the airship may be any user-generated content. For example, users may upload digital photo or video data for displaying a digital photo or video uploaded from a wireless communications device. Media content providers, broadcasters, advertisers, etc. may upload photos, logos, videos, multimedia presentations, documents, slideshows, music, etc. to the airship for display and presentation by the airship. Content may be uploaded (and cached) or streamed. Users may interact with the displayed content using a wireless communications device by highlighting, pointing to, editing, annotating content. The airship may also display a multi-player game interface enabling wireless device users to play the multi-player game. The game may be a sports game, board game, card game, casino-type game, lottery, bingo, etc.

The airship thus becomes a media hub for receiving, displaying and optionally also broadcasting digital content in real-time to users who are in the immediate vicinity, e.g. news, TV shows, movies, sports events, weather alerts, traffic reports, stock market data, event information, location-based advertising, etc. TV stations may transmit content to the airship via satellite or ground stations. Web content may be uploaded or streamed using protocols such as TCP/IPv4, TCP/IPv6, TCP/IPv4v6, PPP, FTP-Server, TELNET in combination with suitable security protocols such as IPSec/IKE, SSL, etc. Web content may be served using HTTP. Content may also be transmitted from one airship to another. Alternatively, two or more airships may coordinate the simultaneous presentation of information/content to the same group of users, i.e. airship A may present content A while airship B presents content B that is related to, synergistic with, content A. As another example, airship A may present content is a first language while airship B presents the same content but in a second language. The digital content displayed and/or broadcast by the airship thus enables the airship owner to sell or auction advertising space on the display screen to the highest bidder. Thus, in one embodiment, the memory and processor are configured to determine real-time pricing for ad space on the display screen, transmit the pricing to a plurality of wireless communications devices, receive bids from one or more of the wireless communications devices, and receive an ad from a bid-winning wireless communications device for displaying on the display screen of the airship.

The airship may also optionally function as a communication hub (or communication relay subsystem) for relaying communications. For example, in one embodiment, the airship may include a satellite transceiver 250 for relaying communications from wireless communications devices 100 via a satellite link to an orbiting communications satellite 70 and vice versa. In another embodiment, the airship may also use its cellular transceiver 240 (e.g. GSM, LTE, HSPA/HSPA+, CDMA/EVDO, etc.) to relay cellular communications from the wireless devices 100 to a base station tower 50 and vice versa. Alternatively, the airship may include a wireless repeater for relaying cellular signals. For example, a base station tower may be damaged, out of range from the ground, or out of power, in which case the airship provides the gateway to the internet for wireless devices that would otherwise be unable to connect to the internet. This may be the case in war zones, failed states and disaster areas. The airship may also have a Wi-Fi transceiver 260 that acts as a Wi-Fi hotspot to provide access to the Internet 10 or to any other data network for nearby mobile devices. In other words, the airship can function as a Wi-Fi hotspot to enable local wireless devices to connect to the airship as a gateway to the Internet.

With its connectivity to the internet via a satellite uplink and/or a cellular connection, the airship thus functions as a communications hub and/or media hub, enabling mobile devices to connect to the Internet via Wi-Fi and/or cellular links the airship. This airship thus enables mobile web browsing and internet connectivity for mobile devices that would otherwise be unable to connect to the Internet 10, which is extremely useful in places that have no wireless service or where service is inadequate.

Alternatively or additionally, the airship may be used as a communication hub to interact with a group or crowd (i.e. a group or crowd of users having respective wireless communications devices). For example, the memory and processor of the communication hub of the airship may be configured to broadcast data using the radiofrequency transceiver on the airship to a plurality of wireless communications devices and to receive data representing votes from one or more of the plurality of wireless communications devices.

Although the airship described above may be embodied in different forms, the most advantageous form is currently believed to be the one shown by way of example in the illustrated embodiment of FIG. 2 in which the airship is a hybrid airship. For the hybrid airship depicted by way of example in FIG. 2, the envelope comprises a non-rigid wing-shaped inflatable structure. This wing-shaped inflatable structure comprises an aerofoil geometry to provide aerodynamic lift in addition to the buoyancy provided by the lifting gas (hydrogen or helium gas) inside the envelope. Inside the envelope are one or more plurality of gas-containing cells. As shown in FIG. 2, the hybrid airship has a cabin or cockpit, a landing gear (fixed or retractable), propellers for providing forward thrust to the airship and control surfaces for controlling the airship during flight. In some embodiments, the propellers can not only provide forward thrust to fly but also provide vectored thrust to hover, for example when acting as a media and/or communication station.

Solar radiation collecting elements (e.g. photovoltaic solar panels 202) collect solar radiation to generate electric power from the solar radiation. The solar panels may be mounted on a solar panel attachment web to the outer surface of the envelope. The solar energy is used to power electric motors such as the primary electric motors and the auxiliary motor shown in the figures. These motors drive propellers for providing the forward thrust. The electric power from the solar panels is also used to power onboard electronics (e.g. communication gear, navigation equipment, anti-collision lights, onboard lighting, heating, cooling, ventilation, etc.). Excess electric power may be stored in an energy storage system, e.g. an electric power storage system comprising batteries or ultra-capacitors onboard the airship. The electric power from the solar panels (or from the batteries or ultra-capacitors) is also used for powering the communication and media hub system (processor, memory, transceiver, etc.) and the airship display screen. Because the airship is solar-powered, the airship is entirely self-reliant and self-sufficient, and is thus able to travel into a disaster zone, war zone, failed state or into places where there are no roads, no fuel and no communication infrastructure.

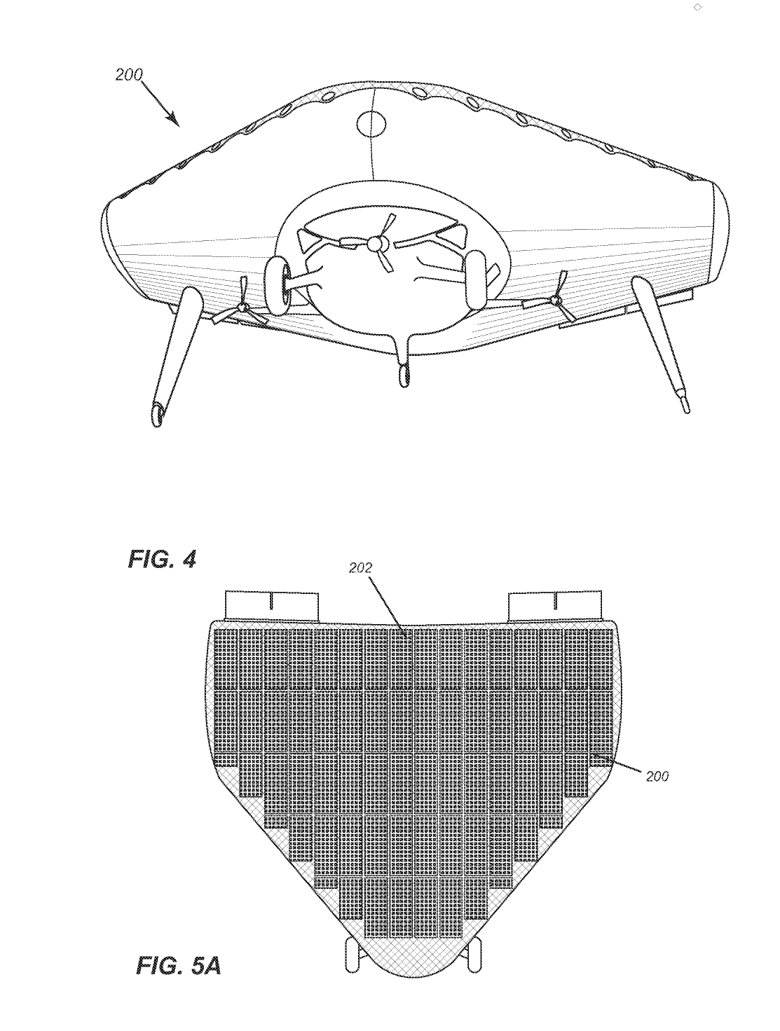

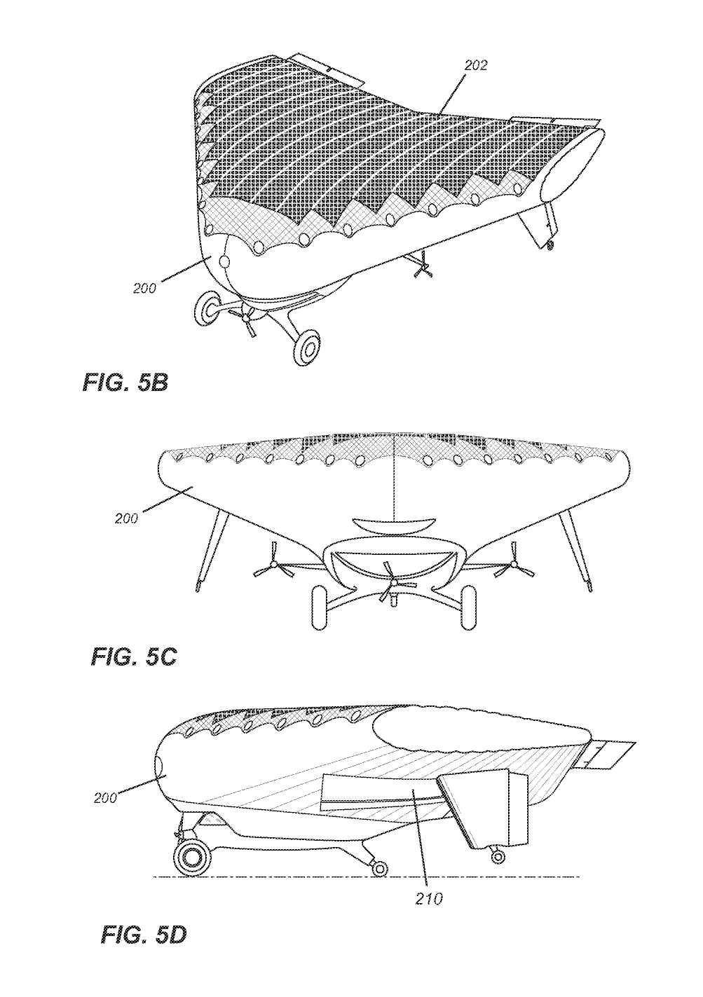

FIGS. 3 and 4 depict two examples of a hybrid airship having display screens. In these examples, the display screens depict various ads, logos, etc. These can be uploaded to the airship and thus dynamically changed. The shape, size, aspect ratio, appearance and location of the display screens may be changed. What is depicted in these figures is therefore only two specific examples.

FIG. 5A-5F depict another example of a hybrid airship having two display screens, each capable of displaying images, video, live media, multimedia, etc. The shape, size, aspect ratio, appearance and location of the display screens may be changed. What is depicted in these figures is therefore only one example.

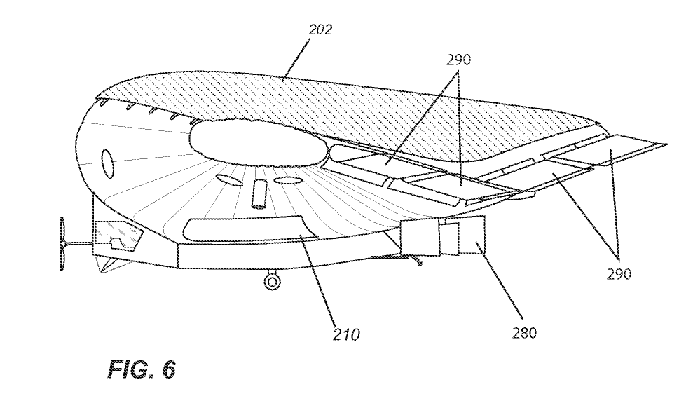

FIG. 6 depict another embodiment of a hybrid airship 200 having solar panels 202 and an external display screen 210. The hybrid airship 200 depicted by way of example in FIG. 6 has a rudder 280 and additional horizontal control surfaces 290 at the trailing edge to replace the two vertical stabilizers shown in the previous embodiment of FIGS. 2-5.

Although the illustrations depict an airship, and in particular a hybrid airship, the invention may be implemented on any other airborne station. The airborne station may be any type of air vehicle, whether manned or unmanned, including aircraft, airships, hybrid airships, tethered or untethered aerostats, dirigibles, or balloons, or the like.

This airborne station thus becomes an airborne communication station, an airborne communication and media hub or an airborne media hub. In the first implementation, the airborne station is an autonomous self-powered airborne communication station that includes a gas-containing envelope for containing a lifting gas, solar panels on the envelope for generating energy and a communication relay subsystem having a radiofrequency transceiver powered by the energy from the solar panels for relaying a communication signal between a wireless communications device and a base station transceiver. In most embodiments, as depicted in the figures, the envelope has a wing-shaped inflatable structure having an aerofoil geometry that creates aerodynamic lift in addition to buoyancy provided by the lifting gas inside the envelope. In these illustrated embodiments, the wing-shaped inflatable structure includes photovoltaic solar panels on its upper surface but these panels may also be elsewhere, e.g. on the fuselage or even on the underside of the wings. The communication relay subsystem includes one or more transceiver chips configured to relay cellular signals (voice and data) and to provide Wi-Fi Internet access or via another equivalent short-range wireless protocol.

In the implementation of the autonomous self-powered airborne station as a communication and media station, the airborne station also includes the gas-containing envelope for containing the lifting gas, the solar panels on the envelope for generating energy, and the communication relay subsystem powered by the energy from the solar panels. In addition, the aircraft includes an external display that is also powered by the energy from the solar panels, the display being disposed on the envelope for displaying digital media content. In one embodiment, the display is subdivided into screen portions for simultaneously displaying different content. The content may include user-generated content uploaded from wireless communications devices. A bid-management processor may be provided to process bids received from users for bidding for ad space on the display or in one or more of the screen portions.

In the implementation of the autonomous self-powered airborne station as just the media hub, the airborne station includes the external display powered by the energy from the solar panels but does not include the communication relay subsystem.

Although the illustrated embodiments depict a hybrid airship, it should be appreciated that the inventive concept(s) may be applied to other types of airships and indeed other types of aircraft or flying machines. Solar panels may be mounted to the fuselage and/or wings of an aircraft. One or more display screens may also be mounted to the fuselage and/or wings of the aircraft to display digital content and to broadcast and relay data in the manner described above.

### Methods

The present invention enables various new methods of using an airship or airborne station for the purposes of communicating information, either visually via the display screen or wirelessly by broadcasting data to nearby devices.

In the former case, the airship or airborne station uses an external display screen to display digital content. In addition, the airship or airborne station may also function as an onboard communication and media hub for receiving, broadcasting or relaying data as described above.

The airship or airborne station may thus be used to display both static images (e.g. photos, composite images, etc.) and dynamic images (e.g. video).

For static image display, the airship or airborne station receives image data from an image data source and then displays this data as image content on its external display screen. The image data may be received from an onboard memory or storage device, from a web server hosting a website, from a ground station by radiofrequency (wireless) link, e.g. cellular or Wi-Fi, from another airborne station (e.g. another aircraft or airship or airborne station) or from an orbiting satellite, etc. The image data may also be received from a wireless communications device, smart phone, mobile device, PDA, tablet, laptop or any other device capable of transmitting data over the air.

This static image display technology enables a number of novel business methods:

1) Because the display screen can change its content, the airship or airborne station can be used by multiple sponsors as opposed to a single sponsor (e.g. Goodyear). This display screen can be used for a variety of purposes including, but not limited to, community support and crowdsourcing.

2) User-generated content can be uploaded directly to the airship or airborne station from a mobile user, thereby turning the airship's or airborne station's display screen into a real-time messaging board.

3) The airship or airborne station can be used to drive web traffic to a web site.

4) Line-of-sight users may communicate directly with the airship or airborne station and may download data from the airship or airborne station.

5) The airship or airborne station enables integrated media campaigns (by virtue of the synergy between the mobile web and the airship or airborne station).

6) It becomes possible to crowdsource venture capital by creating competition over ad space.

7) New airship financing options become available, e.g. (a) financing a ship by displaying a logo/ads; (b) selling advertising space on an airship or airborne station owned or leased by a media company (c) selling a preference interest to receive revenues on media rights generated by the display board on the airship or airborne station.

Dynamic imagery (live media) can also be used to enable a variety of other novel business methods:

1) A mosaic or patchwork of ads on the display screen (as shown for example in FIG. 3 and FIG. 4) enables advertisers to bid on the price per pixel per unit time.

2) The airship or airborne station enables voting from a crowd (e.g. text voting to airship). In low buying power environments, e.g. in Africa, the airship or airborne station's communications may be independent from the local carrier/network operator on the ground. Local users may communicate with the airship or airborne station and link to the internet via a satellite link, for example, to bypass the local network carrier.

3) Bidding wars may be unleashed for suppliers to upgrade the airships or airborne stations (the bidding wars may be launched and managed through the interactive media screen), e.g. for new solar panels, new gondola/fuselage, new batteries, new envelope, etc.

4) Because of the mobility and self-sufficiency of the solar-powered airship or airborne station, live media may be delivered to virtually any place on earth.

5) Direct mobile-to-airship uploading of photos in real-time to a real-time rescue relief poster board in the context of disaster relief efforts (e.g. at a disaster site, users can upload photos of lost children or missing family members onto the dynamic board, or users may post a wanted ad, police warning, infectious disease/pandemic outbreak alert, weather alert, news, etc).

6) Ad space may be sold or auctioned to advertisers who wish to sponsor a community service such as posting photos of lost children at a disaster site, posting weather alerts, or posting any other useful community-relevant information, etc.

As will be appreciated, this airship or airborne station enables many new methods of using the airship or airborne station, including some new business methods.

In another implementation, the airborne station may be powered by hydrogen or by another fuel. The hydrogen or other fuel may be used instead of solar energy or to supplement the solar energy.

This new technology has been described in terms of specific implementations and configurations which are intended to be exemplary only. Persons of ordinary skill in the art will appreciate that many obvious variations, refinements and modifications may be made without departing from the inventive concepts presented in this application. The scope of the exclusive right sought by the Applicant(s) is therefore intended to be limited solely by the appended claims.

1-31. (canceled)

32. An airship comprising:
a gas-containing envelope for containing a lifting gas;
solar panels on the envelope for providing energy to an energy storage system;
an external display screen powered by the energy storage system;
a radiofrequency transceiver for receiving data for the display screen, wherein the transceiver is powered by the energy storage system;
a memory powered by the energy storage system for storing data received by the transceiver; and
a processor, also powered by the energy storage system, for processing the data stored by the memory and for causing the data to be displayed as digital content on the external display screen,
wherein the memory and processor are configured to:
determine real-time pricing for ad space on the display screen;
transmit the pricing to a plurality of wireless communications devices;
receive bids from one or more of the wireless communications devices; and
receive an ad from a bid-winning wireless communications device for displaying on the display screen of the airship.

33. The airship as claimed in claim 32, wherein the data is digital photo or video data for displaying a digital photo or video uploaded from a wireless communications device.

34. The airship as claimed in claim 32, further comprising a satellite transceiver for relaying communications via a satellite link between wireless communications devices and an orbiting satellite.

35. The airship as claimed in claim 32, wherein the envelope comprises a non-rigid wing-shaped inflatable structure.

36. The airship as claimed in claim 35, wherein the non-rigid wing-shaped inflatable structure comprises an aerofoil geometry to provide aerodynamic lift in addition to the buoyancy provided by the lifting gas inside the envelope.

37. A method of using an airship having an external display screen on a gas-containing envelope of the airship, the method comprising:
collecting solar energy using solar panels on the envelope;
storing energy in an energy storage system;
receiving data representing digital content by a radiofrequency transceiver powered by the energy storage system; and
storing data received by the transceiver in a memory powered by the energy storage system; and
processing the data stored by the memory by a processor also powered by the energy storage system;
displaying the digital content on the external display screen using the stored solar energy
determining real-time pricing for ad space on the display screen;
transmitting the pricing to a plurality of wireless communications devices;
receiving bids from one or more of the wireless communications devices; and
receiving an ad from a bid-winning wireless communications device for displaying on the display screen of the airship.

38. The method as claimed in claim 37, wherein receiving the data representing the digital content comprises wirelessly receiving user-generated content from a wireless communications device.

39. The method as claimed in claim 38, further comprising wirelessly uploading a digital photo or video from the wireless communications device.

40. The method as claimed in claim 37, further comprising relaying communications from a plurality of wireless communications devices via a satellite link.

41. An airborne station comprising:
a gas-containing envelope for providing lift for the airborne station;
solar panels on one or both of the envelope for providing energy;
an external display screen powered by the energy from the solar panels;
a radiofrequency transceiver for receiving data for the display screen, wherein the transceiver is powered by the solar panels;
a memory powered by the solar panels for storing data received by the transceiver; and
a processor, also powered by the solar panels, for processing the data stored by the memory and for causing the data to be displayed as digital content on the external display screen, wherein the memory and processor are configured to:
determine real-time pricing for ad space on the display screen;
transmit the pricing to a plurality of wireless communications devices;
receive bids from one or more of the wireless communications devices; and
receive an ad from a bid-winning wireless communications device for displaying on the display screen of the airship.

42. The airborne station as claimed in claim 41, wherein the data is digital photo or video data for displaying a digital photo or video uploaded from a wireless communications device.

43. The airborne station as claimed in claim 41, further comprising a satellite transceiver for relaying communications via a satellite link between wireless communications devices and an orbiting satellite.

44. The airborne station as claimed in claim 41, wherein the airborne station is an airship.

45. The airborne station as claimed in claim 44, wherein the envelope comprises a non-rigid wing-shaped inflatable structure.

46. The airborne station as claimed in claim 45, wherein the non-rigid wing-shaped inflatable structure comprises an aerofoil geometry to provide aerodynamic lift in addition to the buoyancy provided by the lifting gas inside the envelope.

47. The airborne station as claimed in claim 41, comprising an energy storage system for storing energy from the solar panels.

48. An autonomous self-powered airborne communication and media station comprising:
a gas-containing envelope for containing a lifting gas;
solar panels on the envelope for generating energy;
a communication relay subsystem powered by the energy from the solar panels;
an external display that is also powered by the energy from the solar panels, the display being disposed on the envelope for displaying digital media content wherein the display is subdivided into screen portions for simultaneously displaying different content, wherein the content includes user-generated content uploaded from wireless communications devices; and
a bid-management processor for processing bids received from users for bidding for ad space on the display or in one or more of the screen portions.
